(19) United States
(12) Patent Application Publication
(10) Pub. No.: US 2011/0165494 A1
(43) Pub. Date: Jul. 7, 2011

(54) FUEL CELL SEAL

(76) Inventor: Jean Yamanis, South Glastonbury, CT (US)

(21) Appl. No.: 13/062,771

(22) PCT Filed: Oct. 22, 2008
(86) PCT No.: PCT/US2008/080667

§ 371 Date: Mar. 8, 2011

(51) Int. Cl. H01M 8/24; H01M 8/04; H01M 8/00

(52) U.S. Cl. 429/468; 429/516; 429/535

(57) ABSTRACT

An exemplary fuel cell seal assembly includes a first layer, a second layer; and a third layer that limits movement of hydrogen, oxygen, or both between the first layer and the second layer within a fuel cell.

### TECHNICAL FIELD

This disclosure relates generally to fuel cells and, more particularly, to a sealing arrangement for a fuel cell.

### DESCRIPTION OF RELATED ART

Fuel cell assemblies are well known. One type of fuel cell is a solid oxide fuel cell (SOFC). As known, many SOFCs include a tri-layer cell having an electrolyte layer positioned between a cathode electrode and an anode electrode. An interconnector near the anode electrode and another interconnector near the cathode electrode facilitate electrically connecting the fuel cell to an adjacent fuel cell within a fuel cell stack assembly.

Seals help control flow of fluid, such as fuel and oxidant, within the fuel cell stack assembly. For example, some seals are used to seal areas between the cell and a fuel cell frame. Other seals are used to control flow near the interfaces of adjacent fuel cells. Some SOFCs include silver and copper seals. As known, silver and copper or silver and copper oxide (CuO) seals bond well to metal and ceramics and are thus particularly well-suited for sealing within fuel cell environments.

Fuel cell seals are often positioned near more than one atmosphere. For example, seals positioned near the cathode electrode and the anode electrode of the fuel cell are near both a hydrogen bearing atmosphere and an oxygen bearing atmosphere. As known, the stability of the silver and copper or silver and copper oxide seals decreases more rapidly when the seal is exposed to multiple atmosphere than when the seal is exposed to one atmosphere. For example, hydrogen and oxygen moving through the seal can combine to create superheated steam, which can create porosity and degrade the seal over time and disadvantageously reduce the seal's useful life.

### SUMMARY

An exemplary fuel cell seal assembly includes a first layer, a second layer, and a third layer that limits movement of hydrogen, oxygen, or both between the first layer and the second layer within a fuel cell.

An exemplary method of sealing a fuel cell fluid including blocking movement of a fuel cell fluid using a barrier layer and limiting movement of evaporative components from the barrier layer using an alloy. Exemplary movements include gradient driven flow or diffusional processes in solid state media, in porous media, in bulk fluid space, at interfaces, etc.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 shows a schematic view a fuel cell stack assembly.

FIG. 2 shows a schematic view of a solid oxide fuel cell within the FIG. 1 assembly.

FIG. 3 shows a partial exploded view of a portion of FIG. 2.

FIG. 4 shows a top view of the FIG. 3 in a sealed position.

FIG. 5 is a section view through line 5-5 of FIG. 4.

FIG. 6 shows a section view through a portion of the FIG. 1 fuel cell stack assembly.

FIG. 7 shows a section view through another portion of the FIG. 1 fuel cell stack assembly.

### DETAILED DESCRIPTION

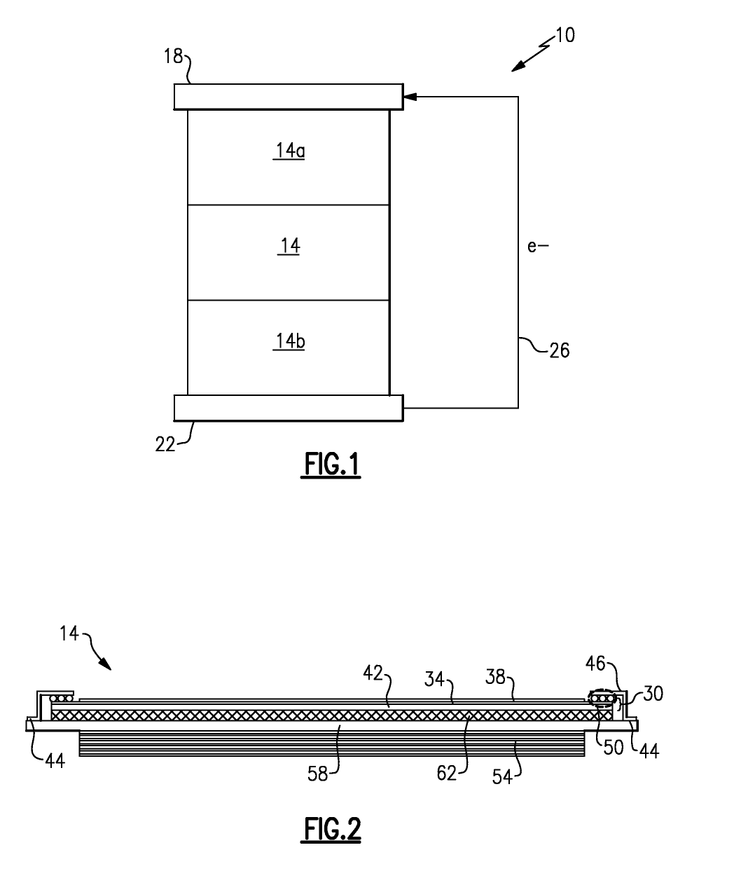

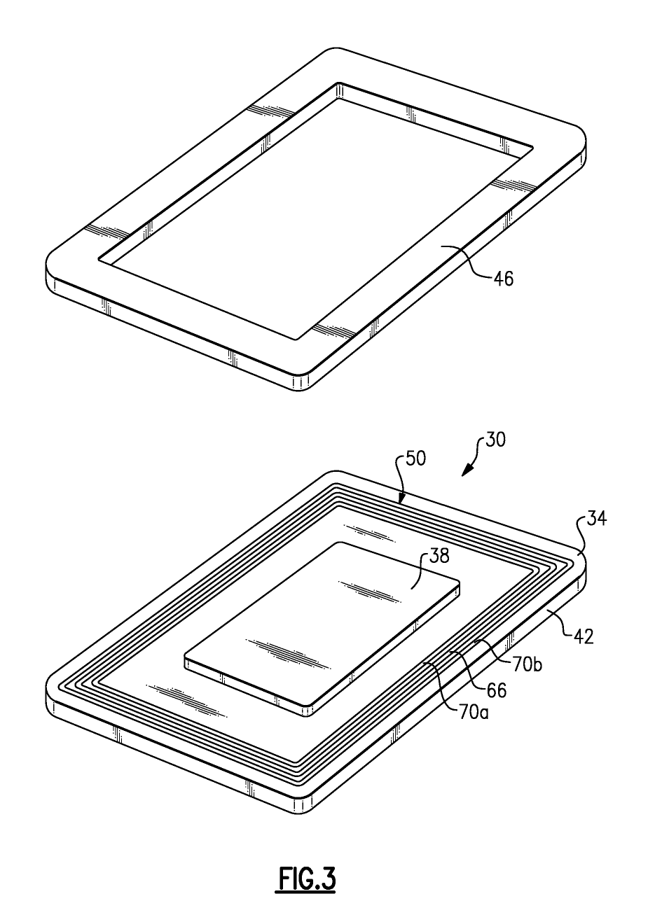

Referring to FIGS. 1 and 2, an example fuel cell stack assembly 10 includes a solid oxide fuel cell (SOFC) 14 positioned between a SOFC 14a and a SOFC 14b. A first metal plate 18 and a second metal plate 22 are secured at opposing ends of the fuel cell stack assembly 10. Electrons travel from the SOFC 14a, to the SOFC 14, to the SOFC 14b, and to the second metal plate 22, which provides electric power from the fuel cell stack assembly 10 along path 26 in a known manner. The SOFC 14 is also referred to as the fuel cell stack repeat unit in some examples.

The example SOFC 14 includes a tri-layer cell 30. This example includes an electrolyte layer 34 positioned between a cathode electrode layer 38 and an anode electrode layer 42. A mounting sheet 46 is mounted to the cell 30 and bonds with a seal assembly 50 to control fluid flow within the SOFC 14. The electrolyte layer 34 is also bonded to the seal assembly 50. The cathode electrode layer 38 extends partially through the mounting sheet 46 toward a cathode interconnector 54. The anode electrode layer 42 is mounted to a separator plate 58 by means of an anode interconnector 62. Fuel moves through the anode interconnector 62 to the tri-layer cell 30. In this example, the seal assembly 50 and a welded joint 44 facilitate hermetically sealing, with the exception of the fuel input and output ports which are not shown, the anode electrode layer 42, the anode interconnector 62, and the fuel between the separator plate 58 and the mounting sheet 46.

In this example, the cathode interconnector, the separator plate 58, and the anode interconnector 62 are each separate components that are joined together by a welding operation, for example. In another example, the cathode interconnector 54, the separator plate 58, and the anode interconnector 62 are formed from a single part, such as by a stamping or another metal forming operation, to form a monolithic bipolar plate. In such an example, portions of the bipolar plate are bent or otherwise configured for attachment to the mounting sheet 46.

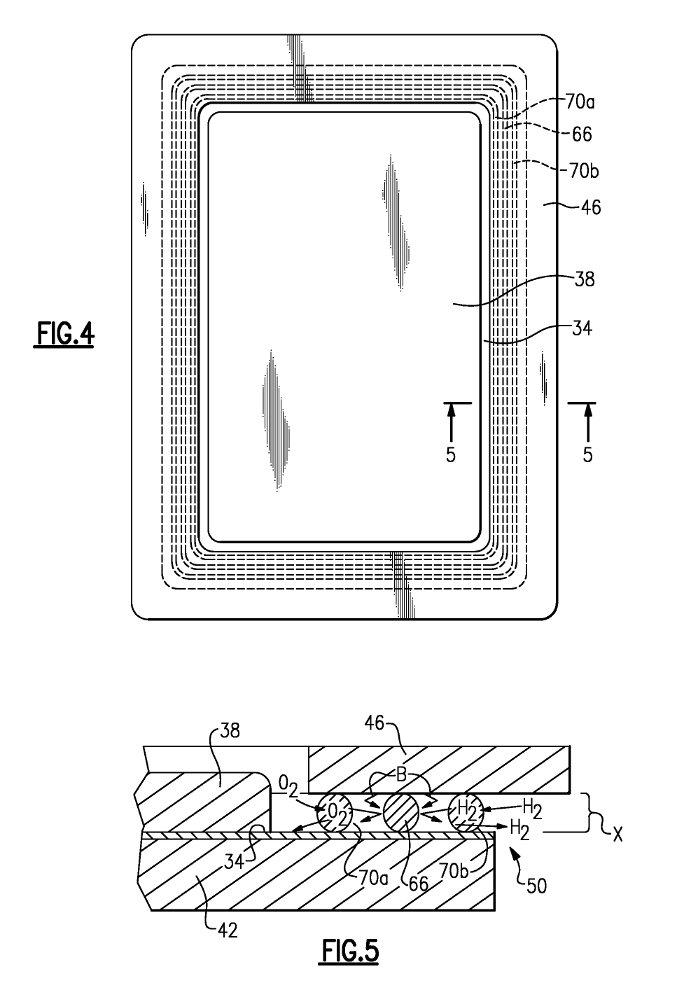

Referring now to FIGS. 3 to 5 with continuing reference to FIG. 2, the seal assembly 50 in this example includes a barrier 66 positioned between a first alloy layer 70a and a second alloy layer 70b. In this example, the barrier 66 is spaced about 1 mm from each of the alloy layers 70a, 70b. The example barrier 66 and the alloy layers 70a, 70b are also about 1 mm wide each. Other examples include different combinations of spacing, width and thickness. The spacing and width dimensions in some examples range from about 0.5 mm to 5 mm.

In another example, the barrier 66 contacts one or both of the alloy layers 70a, 70b.

In this example, the first alloy layer 70a is exposed to the fuel cell air stream, as known in the fuel cell art. Oxygen from the air stream dissolves in first alloy layer 70a and, over time, some oxygen escapes into the space between the first alloy layer 70a and barrier 66. The second alloy layer 70b is exposed to the fuel stream. Hydrogen from the fuel stream dissolves in the second alloy layer 70b and, over time, some hydrogen escapes into the space between the second alloy layer 70b and barrier 66. The barrier 66, however, blocks any movement of oxygen and hydrogen between the alloy layers 70a, 70b. Thus, the barrier 66 substantially blocks hydrogen and oxygen from flowing through the seal assembly 50 and prevents them from combining to form superheated steam. The alloy layers 70a, 70b are thus each exposed to only one atmosphere (oxygen or hydrogen respectively, in this example).

The barrier 66, in this example, comprises a deformable, self-healing, non-crystallizing glass. Other example materials suitable for use as the barrier 66 include glass-ceramics, glass-metal composites, or other materials suitable for substantially blocking hydrogen and oxygen from coming into contact with each other in the first alloy 70a and the second alloy 70b. These example materials retain their structural integrity during steady state operation at the fuel cell operating temperatures of 500° C. to 1000° C.

Over time, the barrier 66 generates evaporative components, which can contaminate the SOFC 14. In this example, boron (B) oxide or other boron compounds are some of the evaporative component of the barrier 66. Other example evaporative components include phosphorous oxides and other compounds, alkali metal oxides and other compounds, alkaline earth metal oxide, and alkaline earth metal hydroxide.

The first alloy layer 70a and the second alloy layer 70b both limit movement of evaporative components from the barrier 66 away from the seal assembly 50 into other parts of the fuel cell. Positioning the barrier 66 between the first alloy layer 70a and the second alloy layer 70b thus effectively traps or encapsulates the evaporative components of the barrier 66, which prevents the evaporative components of the barrier 66 from escaping and contaminating portions of the fuel cell stack assembly 10.

The alloy layers 70a, 70b in this example include silver and copper or silver and copper oxide (CuO). In other examples, one or both of the alloy layers 70a, 70b also includes other noble metals, such as palladium (Pd), platinum (Pt), gold (Au), etc. In other examples, one or both of the alloy layers 70a, 70b also includes materials that provide modification of thermal expansion characteristics or reinforcement, such as ceramics or base metals. The set of these materials may be referred to as additives or modifiers. Ceramic additives may include zirconia, barium titanate or strontium titanate. Base metal additives may include tin (Sn), aluminum (Al), nickel (Ni), zinc (Zn) and combinations thereof. The alloy layers in one example comprise the same materials and composition. In another example, the alloy layers are not identical.

The example seal assembly 50 bonds to the electrolyte layer 34, which is substantially pore free and dielectric. As the electrolyte layer 34 is dielectric, the mounting sheet 46 is optionally dielectric. That is, there is substantially no electron flow between the anode layer 42 and the mounting sheet 46. In some examples, the mounting sheet 46 includes a protective skin, such as an alumina protective skin, to lessen chemical interactions between the seal assembly 50 and the mounting sheet or to provide dielectric separation between adjacent SOFC repeat units in alternate attachment options.

Heat treatment or firing processes bond the example seal assembly 50. In one example, heating the seal assembly 50 within an air furnace having a temperature of about 800° C. to 1000° C. is effective for bonding the seal assembly 50 to the mounting sheet 46 and the anode electrode layer 42.

In this example, the mounting sheet 46 is substantially metallic, and the electrolyte layer 34 is a ceramic based material, i.e., yttria-stabilized zirconia in one example. In one example the material forming the barrier 66 and the material forming the alloy layers, 70a, 70b are selected based on their ability to bond or sinter to the mounting sheet 46 and the electrolyte layer 34 within a similar temperature range.

Example processes for arranging metallic alloy layers 70a, 70b that comprise silver and copper or silver and copper oxide powders include dispensing the layers 70a, 70b as a paste on the desired sealing area, cutting the layers 70a, 70b from plastic tapes made from metal and oxide powders and organic carriers, or cutting the layers 70a, 70b from metal foils in the case of silver-copper alloys or silver-copper-other metal alloys, wherein other metals comprise Pd, Au, other noble metals, and base metals Al, Ni, tin, and zinc.

Example processes for arranging the glass or glass-ceramic based layers 70a, 70b include dispensing the layers 70a, 70b as paste or dispersion of the glass or glass-ceramic powders in a liquid vehicle on the desired sealing area and cutting the layers 70a, 70b from plastic tapes made from glass or glass-ceramic powders and organic carriers.

The seal assembly 50 is described in this example as sealing generally rectangular components. In other examples, the seal assembly 50 is adapted to accommodate other geometries, such as elliptical, circular, etc. The example seal assembly 50 is also shown as bonding to relatively flat surfaces of the mounting sheet 46 and the anode electrode layer 42. In other examples, the mounting sheet 46, the anode electrode layer 42, or both define a groove or recess that at least partially receives a portion of the seal assembly 50.

The example seal assembly 50 is also described as sealing the cell 30 to the mounting sheet 46 or frame. In other examples, the seal assembly 50 seals between metal components of the SOFC 14 and the adjacent SOFC 14a, 14b. The distance X shown in FIG. 5 between the mounting sheet 46 and the electrolyte layer 34 is substantially less than 1 mm in some examples.

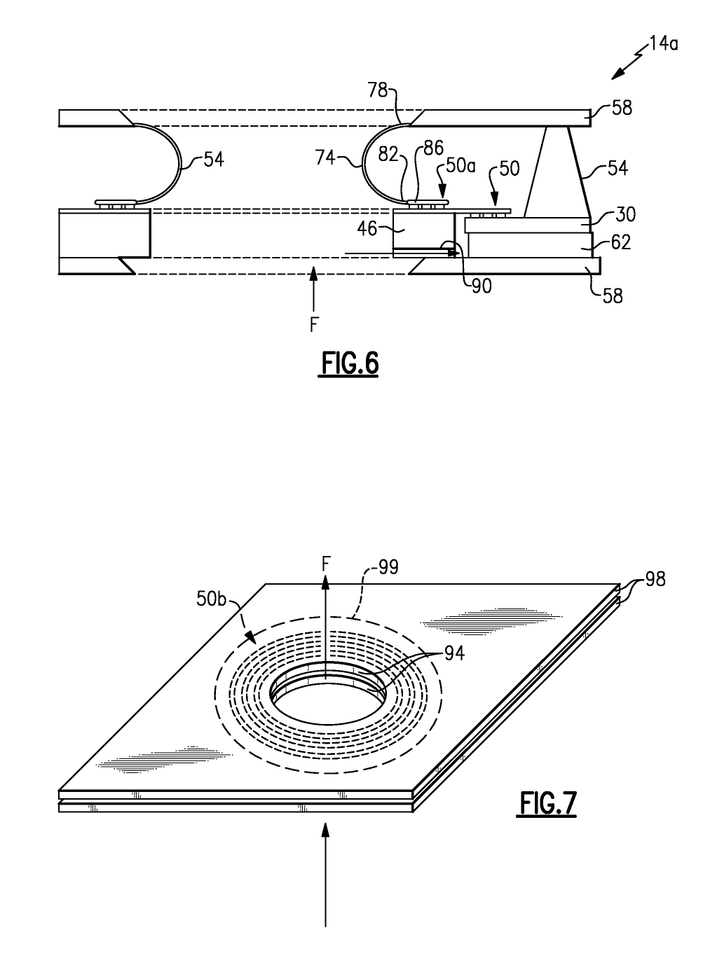

Referring to FIG. 6, in some examples, sealing larger distances is necessary. In such examples, the seal assembly 50a is combined with a spacer 74 to span the larger gaps. The spacer 74 and the seal assembly 50a both block flow and may be designed to bear a mechanical compressive load.

For example, the spacer 74, such as the “C-ring” spacer shown, is used to space the SOFC 14a from an adjacent SOFC and for blocking flow. The example spacer 74 includes a first end 78 welded to the separator plate 58. A second end 82, opposite the first end 78, having a dielectric skin 86, such as alumina skin, for dielectric separation is sealed to the mounting sheet 46 with the seal 50a. The dielectric alumina skin on the second end 82 is formed by oxidation if the alloy used in the fabrication of spacer 74 contains aluminum or can be applied by any suitable process. The dielectric skin 86 is alternatively on the mounting sheet 46 or other areas where the seal 50a seals pairs of metallic parts.

The example spacer 74 is metal and may include different stiffnesses and geometrical designs depending on desired SOFC 14a characteristics. The spacer 74 may be used in other areas of the assembly 10 (FIG. 1) where bridging and sealing substantial gaps is desired.

In the FIG. 6 example, fuel F moves up through the assembly 10 and through a gap 90 to the SOFC 30. Referring now to FIG. 7, in other examples, fuel F moves through the assembly 10 through apertures 94 established by directly adjacent portions 98 of the fuel cell stack assembly 10. The seal assembly 50b facilitates sealing these interfaces. In such examples, one of components 98 comprises a dielectric skin 99 that extend over the portion of the component operative to carry the seal assembly 50b. In another example, the dielectric skin extends across the entire component surface. The thickness of the seal assembly 50b spaces the components 98 from each other.

Features of the disclosed example include a seal having useful life of tens of thousand of hours. Another feature of the disclosed example is a seal structure that exposes silver and copper alloys to one, rather than multiple, atmospheres. Still another feature is a seal that does not introduce undesirable chemical species within the fuel cell.

Although a preferred embodiment has been disclosed, a worker of ordinary skill in this art may recognize that certain modifications are possible and come within the scope of this disclosure. For that reason, the following claims should be studied to determine the true scope of legal protection coverage.

1. A fuel cell seal assembly, comprising:
a first layer;
a second layer; and
a third layer that limits movement of hydrogen, oxygen, or both between the first layer and the second layer within a fuel cell, wherein at least one of the first layer or the second layer is configured to extend from a first fuel cell component to a second fuel cell component, wherein the third layer is configured to extend from the first fuel cell component to the second fuel cell component.

2. The fuel cell seal assembly of claim 1, wherein at least one of the first layer and the second layer comprises silver and copper.

3. The fuel cell seal assembly of claim 1, wherein at least one of the first layer and the second layer comprises silver and copper oxide.

4. The fuel cell seal assembly of claim 2, wherein at least one of the first layer and the second layer comprises silver and copper, and a noble metal selected from a group consisting of Pd, Pt, Au, and combinations thereof.

5. The fuel cell seal assembly of claim 1, wherein at least one of the first layer and the second layer comprises silver and copper, and a base metal selected from a group consisting of Al, Ni, Sn, Zn, and combinations thereof.

6. The fuel cell seal assembly of claim 1, wherein at least one of the first layer and the second layer comprises silver and copper, and a ceramic selected from a group consisting of zirconia, barium titanate, strontium titanate, and combinations thereof.

7. The fuel cell seal assembly of claim 1, wherein at least a portion of the third layer is positioned between the first layer and the second layer.

8. The fuel cell seal assembly of claim 1, where the third layer is spaced from the first layer and the second layer.

9. The fuel cell seal assembly of claim 1, wherein the third layer comprises a glass portion.

10. The fuel cell seal assembly of claim 9, wherein the glass portion is self-healing and deformable.

11. A fuel cell assembly, comprising:
a cell stack assembly; and
a seal associated with the fuel cell assembly, the seal including a barrier having a portion disposed adjacent an alloy that limits movement of evaporative components from the barrier, wherein the barrier of the seal extends from a first fuel cell component to a second fuel cell component.

12. The fuel cell assembly of claim 11, wherein the barrier portion limits flow of hydrogen and oxygen within the fuel cell assembly.

13. The fuel cell assembly of claim 11, wherein the alloy comprises a plurality of layers, the barrier positioned between the plurality of layers.

14. The fuel cell assembly of claim 13, wherein the barrier layer limits movement of hydrogen and oxygen between the plurality of layers.

15. The fuel cell assembly of claim 13, wherein at least one of the layers is positioned for exposure to a hydrogen atmosphere or an oxygen atmosphere.

16. The fuel cell assembly of claim 11, wherein the barrier comprises glass.

17. The fuel cell assembly of claim 11, wherein the alloy comprises silver, copper, and a noble metal, a base metal, or a ceramic, the noble metal being selected from a group consisting of Pd, Pt, Au and combinations thereof, the base metal being selected from a group consisting of Al, Ni, Sn, Zn, and combinations thereof, and the ceramic being selected from a group consisting of zirconia, barium titanate, strontium titanate, and combinations thereof.

18. The fuel cell assembly of claim 11, wherein the fuel cell assembly comprises an anode and a mounting sheet, the seal adhered to both the anode and the mounting sheet.

19. The fuel cell assembly of claim 11, wherein the seal is mounted to a spacer and another portion of the cell stack assembly.

20. A method of sealing an interface in a fuel cell, comprising
blocking movement of a fuel cell fluid using a barrier layer; and
limiting movement of evaporative components away from the barrier layer using an alloy.

21. The method of claim 20, wherein the alloy comprises silver and copper.

22. The method of claim 20, including positioning the alloy adjacent opposing sides of the barrier layer.

23. The method of claim 20, bonding the alloy and the barrier layer to a fuel cell component.
